(19) United States
(12) Patent Application Publication
(10) Pub. No.: US 2013/0066693 A1
(43) Pub. Date: Mar. 14, 2013

(54) CROWD-SOURCED QUESTION AND ANSWERING

(71) Applicants: Thomas Laird-McConnell, Kirkland, WA (US); Steven W. Ickman, Snoqualmie, WA (US); Christopher C. McConnell, Redmond, WA (US)

(72) Inventors: Thomas Laird-McConnell, Kirkland, WA (US); Steven W. Ickman, Snoqualmie, WA (US); Christopher C. McConnell, Redmond, WA (US)

(73) Assignee: Microsoft Corporation, Redmond, WA (US)

(21) Appl. No.: 13/233,002

(22) Filed: Sep. 14, 2011

(51) Int. Cl. G06Q 30/00; G06F 17/30

(52) U.S. Cl. 705/14.11; 707/769; 707/723; 707/E17.014

(57) ABSTRACT

In a crowd-sourced question answering system, the user is allowed to provide clarifying information to eliminate some of the most probable solutions or answers. This allows the user to find less common solutions to a query.

### BACKGROUND

A variety of different community-sourced question and answer systems are currently in use. Such systems generally aggregate questions and allow a community of users to vote on answers submitted in response to those questions. These types of systems enable the crowd to determine the best answers to a particular question by voting on the answers. The current question answering systems then rank the answers based on how likely they are to be a correct answer to a given question, based upon the votes by the crowd. Then, when the question is submitted later, the most likely answers (as determined by the crowd) are provided in a ranked list of answers.

Such systems, however, do have problems. For instance, sometimes the actual answer to a question, or the solution to a problem, is not the most likely answer or solution. In fact, there may be a very large number of possible answers, all of which are given a high ranking because they are relevant to a lot of users. Therefore, the list of highly ranked answers is quite long. However, the actual answer for a specific user may be a less common answer. The long list of most common answers makes it even more difficult for the user to find the less common solution or answer to a given problem or question. That is, if a particular question is common and the user has an uncommon variant of the common question, it can be difficult for the user to find the uncommon solution in current question answering systems.

The discussion above is merely provided for general background information and is not intended to be used as an aid in determining the scope of the claimed subject matter.

### SUMMARY

In a crowd-sourced question answering system, the user is allowed to provide clarifying information to eliminate some of the most probable solutions or answers. This allows the user to find less common solutions to a query.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a crowd-sourced question answering system.

FIG. 2 illustrates one embodiment of proposed solutions associated with factors.

FIG. 3 illustrates a more detailed embodiment of a solution that is associated with factors.

FIG. 4 is a flow diagram illustrating one embodiment of the operation of a portion of the system shown in FIG. 1.

FIG. 5 shows one embodiment of an exemplary user interface.

FIG. 6 shows one embodiment of an exemplary user interface where clarifying information is provided.

FIG. 7 is a flow diagram illustrating one embodiment of the operation of a different portion of the system shown in FIG. 1.

FIG. 8 is one exemplary embodiment of the user interface generated during the operation shown in FIG. 7.

FIG. 9 is a simplified block diagram of one embodiment of a public search system.

FIG. 10 is a simplified flow diagram showing one embodiment of the operation of the system shown in FIG. 9.

FIGS. 11A-11C are exemplary embodiments of user interface displays.

FIG. 12 shows one example of a computing environment.

### DETAILED DESCRIPTION

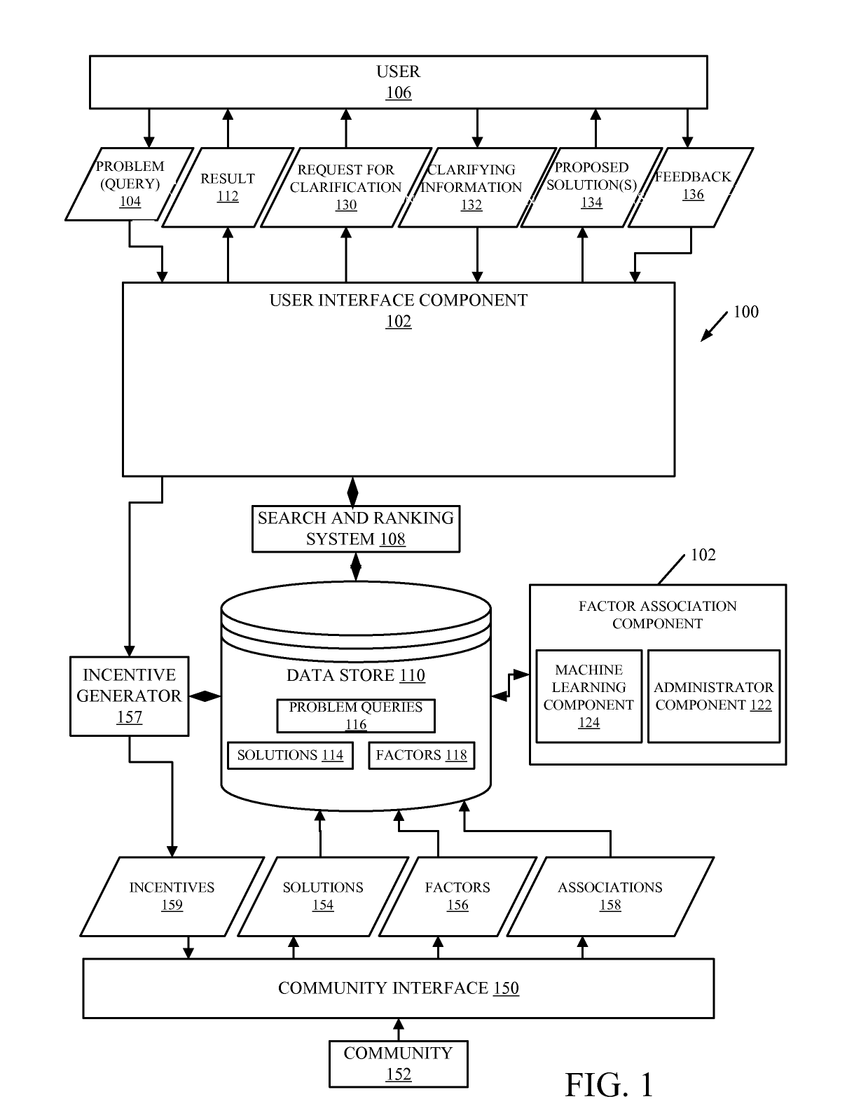

FIG. 1 is a block diagram of one embodiment of a crowd-sourced question answering system 100. System 100 illustrates a user interface component 102 that receives an input query 104 that defines a problem from a user 106. The user interface component provides the input query 104 to search and ranking system 108 that searches data store 110 based on the input query 104 and provides search results 112 in the form of possible solutions to the problem posed by the input query 104.

FIG. 1 shows that data store 110 stores solutions 114, queries 116 and factors 118. Factor association component 120 associates the factors 118 with one another and with both solutions 114 and stored queries 116. This can be done by a user through administrator component 122 or automatically using machine learning component 124 (or both, or using other components). Therefore, when a user 106 submits an input query 104, that input query 104 may match (or be similar to) a stored query 116 that already resides in data store 114 and that has factors 118 associated with it, if no matching (or similar) query 116 is found, then search and ranking system 108 searches for possible solutions 114 in a conventional way, by looking for solutions that are likely relevant to the input query 104. If a matching, stored query 116 is found, search and ranking system 108 searches data store 110 for possible solutions 114 that have similar factors 118 associated with it, as those that are associated with the matching, stored query 116 that matches the input query 104 currently input by user 106. In either case, the possible solutions 114 and associated factors 118 are provided by search and ranking system 108 as results 112 to user 106.

Search and ranking system 108 also provides the associated factors, that are associated with both the matching stored query 116 (if one is found) and possible solutions 114. The factors 118 that are presented to the user as results 112 can be rank ordered by relevance to the input query 104, based on the factors associated with the matching, stored query 116 that matches the input query 104. The relevance can be determined in many different ways, including, for example, by manually associated probabilities input through administrator component 122, learned probabilities that are learned through a statistical or rules-based machine learning component 124, or different combinations thereof. The probabilities or other weights indicate how relevant (or how closely associated) a given factor 18 is to a stored query 116.

In one embodiment, user interface component 102 also provides a request for clarification 130 to user 106. In one embodiment, the request for clarification can simply take the form of the proposed factors 118 that are returned as part of results 112. The user 106 can then select or remove particular factors 118 that are present in or are absent from the user's problem or query 104. In this way, user 106 provides clarifying information 132 to user interface component 102 for use by search and ranking system 108. Based on the factors chosen or removed by user 106, search and ranking system 108 can pivot the presented information accordingly, or can present entirely new information. For instance, based on the factors 118 that are present or absent, as indicated by user 106 in the clarifying information 132, search and ranking system 108 can re-rank the proposed solutions or provide a different or altered set of potential factors, etc. This information is provided, as proposed solutions 134 to user 106.

When the user 106 finds a solution to the problem represented by input query 104, the user also illustratively provides feedback 136. This can take a wide variety of different forms, and in one embodiment, it is simply an acknowledgement by the user 106 that one of the proposed solutions 134 solved the problem posed by input query 104.

Also, in accordance with one embodiment, user interface component 102 can request additional factors from user 106, as part of feedback 136. That is, when the user finds a solution that works, the user acknowledges or approves that solution through user interface component 102. User interface component 102 can prompt user 106 thr additional information about the problem, which can then be stored in data store 110 as additional factors 118 that are associated with the input query 104 input by the user 106 and the solution 114 approved by the user in feedback 136. Also, if there was no matching, stored query 116, then the input query 104 is stored in data store 104 and its associations to the factors 118 and solutions 114 are stored as well. Finally, search and ranking system 1.08 can then re-calculate the probabilities associated with solutions 114, queries 116 and factors 118 stored in data store 110, thr later use. Similarly, factor association component 120 can illustratively use machine learning component 124 to recalculate associations between factors 118, solutions 114 and queries 116 stored in data store 110, based upon the interactions with user 106.

FIG. 1 also shows a community interface 150 that can be used by a community of users 152. Community 152 can use community interface 150 to create or augment data store 110 by providing additional solutions 154, factors 156 associated with solutions 154, and associations 158 that associate factors 156 with various solutions 154 or queries 116 in data store 110. In doing so, community interface 150 may invoke administrator component 122 in factor association component 120, so the members of community 152 can manually associate various factors 156 (input by community 152) with one another, with solutions 154 or with the queries 116 in data store 110, or with all of the above.

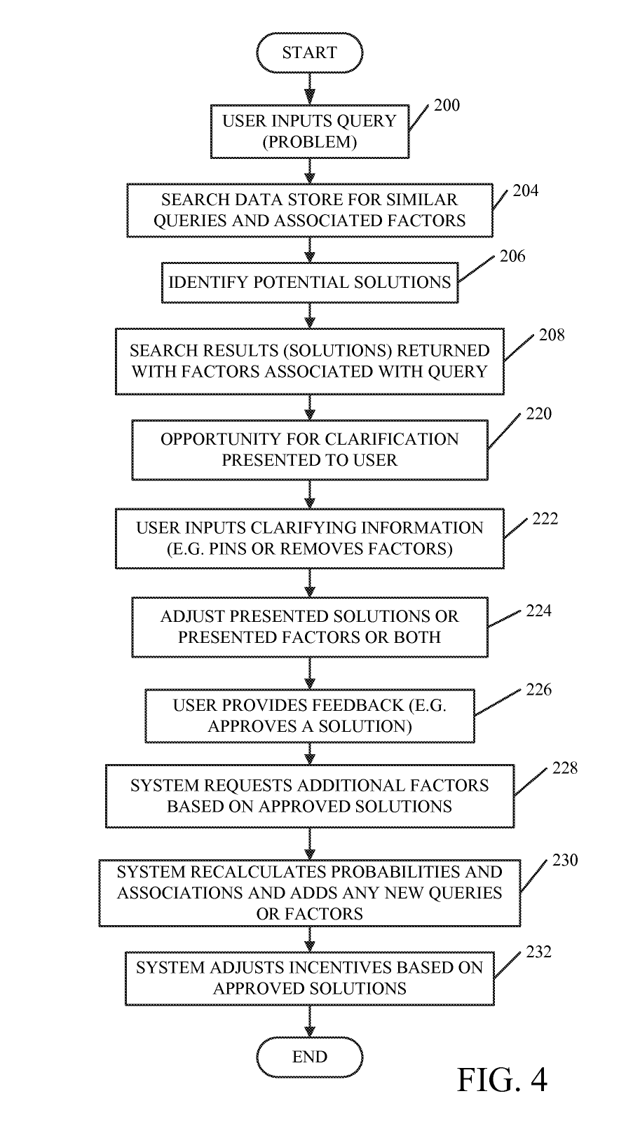

FIG. 1 also shows that system 100 can include incentive generator 157 that provides incentives 159 to community members of community 152 though community interface 150. This is described in greater detail below with respect to FIG. 4.

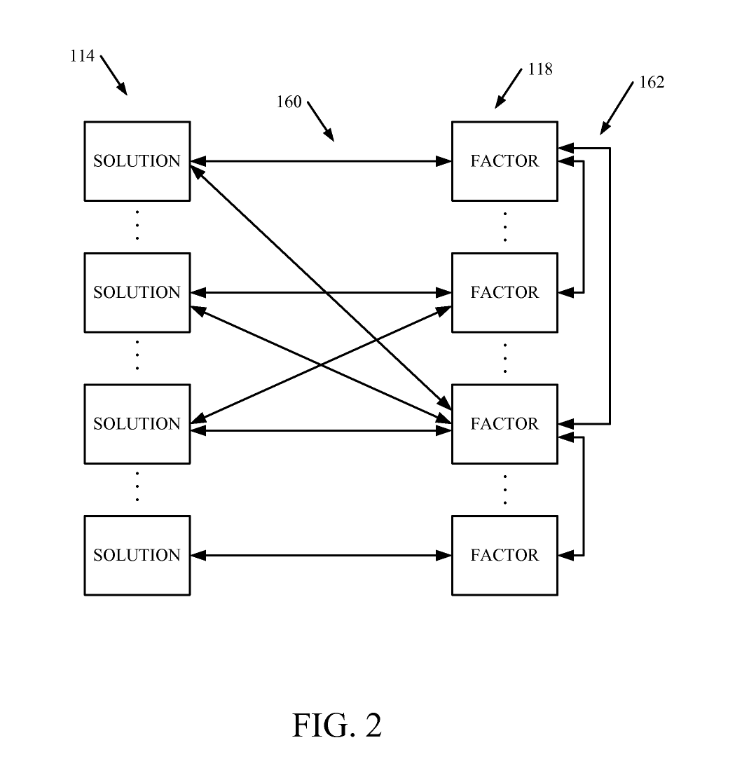

FIG. 2 shows one embodiment of a structure of a portion of data store 110. In the embodiment shown in FIG. 2, a plurality of solutions 114 are stored, as are a plurality of factors 118. Each of the solutions 114 is associated, through associations 160, with one or more factors 118. Each of the associations 160 can also have a strength value associated with it. The strength value indicates the strength of association between a given factor 118 and a given solution 114. As described above, associations 160 can be generated by factor association component 120 either manually, using component 122, or automatically, using machine learning component 124, FIG. 2 also shows that the factors 118 can have associations 162 that associate the factors 118 with one another.

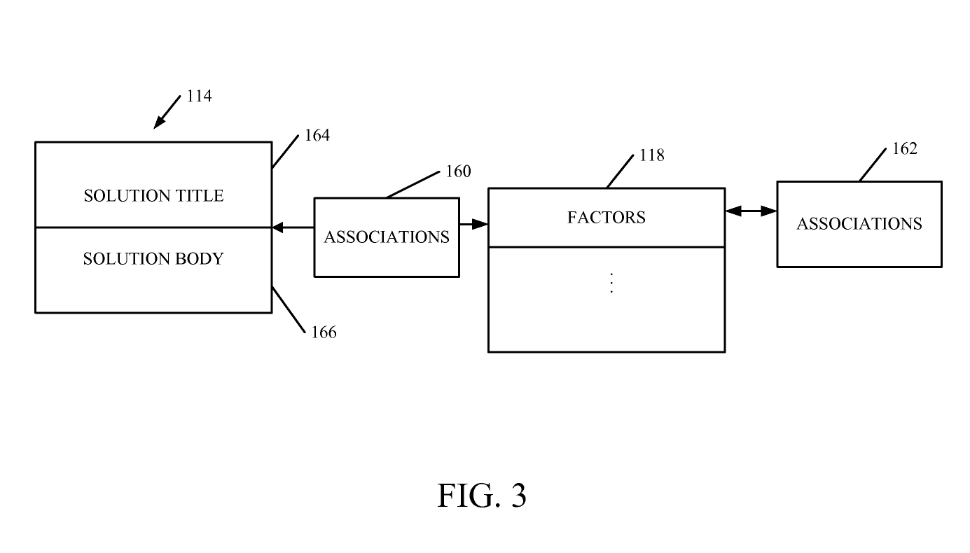

FIG. 3 shows a structure of a portion of data store 110 in more detail. In the embodiment shown in FIG. 3, each solution 114 is illustrated as having a solution title 164 and a solution body 166. The solution title 164 identifies the solution and the solution body 166 elaborates on the solution using text, diagrams, photographs, etc. Each solution 114 is associated (through one of associations 160) with a set of factors 118. Factors 118 can, of course, be associated with one another through associations 162, as well.

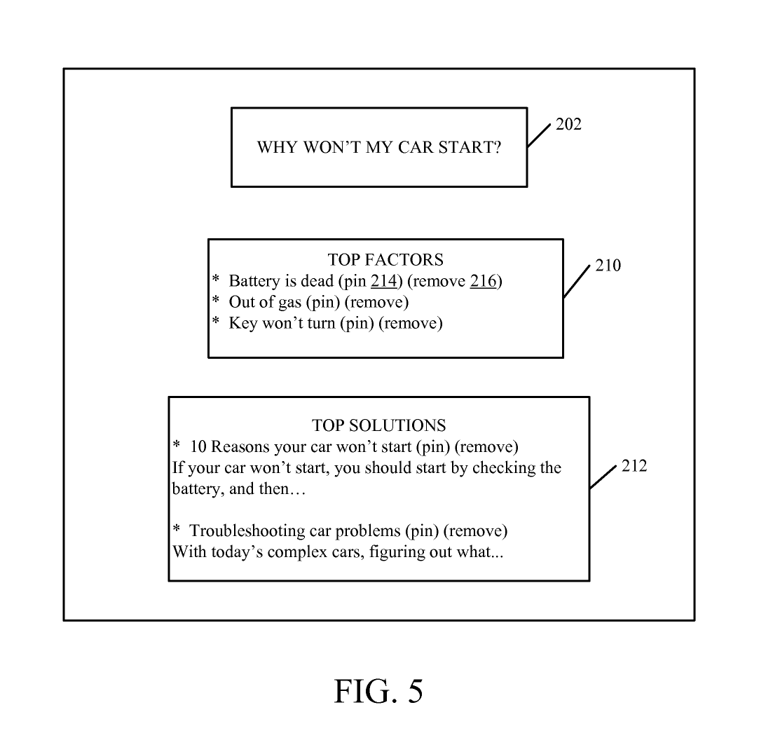

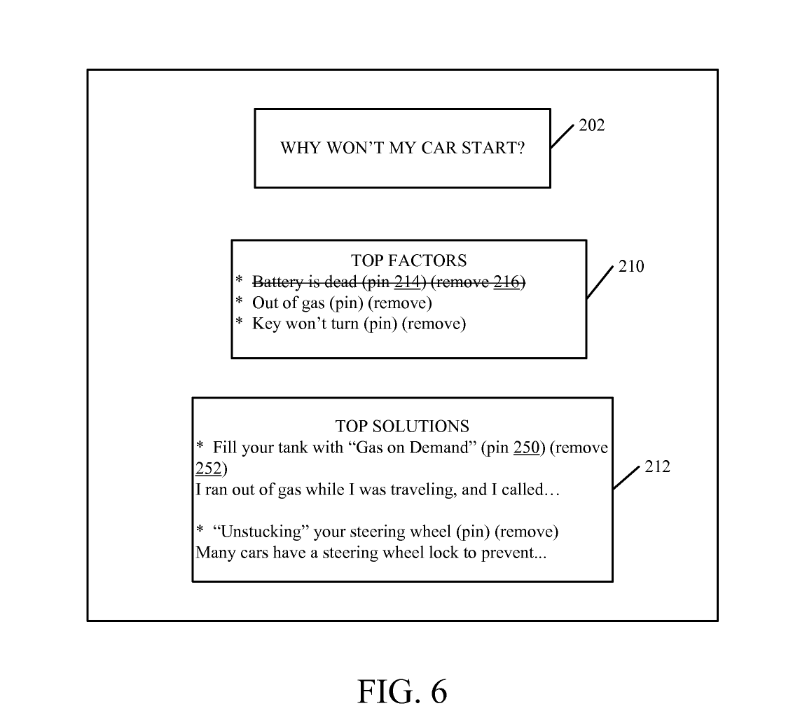

FIG. 4 is one exemplary flow diagram illustrating the overall operation of a portion of system 100 shown in FIG. 1. FIGS. 5 and 6 are illustrative user interface displays generated by user interface component 102, and presented to user 106, FIGS. 4-6 will now be described in conjunction with one another.

FIG. 4 shows that user 106 first inputs a problem in an input query 104 through user interface component 102. This is indicated by block 200 in FIG. 4. In one embodiment, for instance, user 106 does this by typing query 104 into a text box 202 shown in FIG. 5, in the example being described, the input query 104 is “Why won't my car start?”. User interface component 102 passes the input query 104 to search and ranking system 108, which searches data store 110 for matching (or similar) stored queries 116. If a matching query exists, then search and ranking system 108 identifies the matching query 116 and examines the associations between the matching query 116 and factors 118 to find the factors 118 associated with the matching query 116. System 108 also looks for possible solutions 114 that are related to the matching query 116 and that have associated factors 118 that are similar to those associated with the matching query 116. Searching data store 110 for similar queries and associated factors, and identifying potential solutions 114 based on that search are indicated by blocks 204 and 206 in FIG. 4.

Search and ranking system 108 then ranks the possible solutions 114 and associated factors 118 and provides them, through user interface component 102, as results 112. This is indicated by block 208 in FIG. 4, and one embodiment of this is shown in the user interface in FIG. 5.

The user interface of FIG. 5 illustrates that results 112 can be provided to user 106 as a list of top factors 210 and a list of top possible solutions 212. In the example shown in FIG. 5, the top factors 210 associated with the input query 104 input by the user (because they were associated with a matching query 116) and the proposed solutions 212 are “battery is dead”, “out of gas”, and “key won't turn”. Solutions 212 can include additional information, such as the likelihood that the solution will solve the problem in the input query 104, based on known information, based on the factors 210 associated with the input query 104 and solution 212, or based on other information. The user can directly select one of the solutions 212 at this point and view that solution in the same way as a conventional search result.

It can be seen that the user interface of FIG. 5 also offers the user 106 an opportunity to provide clarifying information. For instance, the user can pin (or remove) each of the top factors 210 that apply (or do not apply) to the particular user's problem. Factors are illustratively presented according to the probability of relevance to the input query 104 input by the user 106. In the example illustrated, the “battery is dead” factor is presented first, and this means that most of the solutions that end up resolving the query “Why won't my car start?” are associated, through associations 160, with the factor “battery is dead”.

By providing the factors 210 as illustrated in FIG. 5, the user 106 can interact with the factors 210 in order to provide clarifying information 132 to search and ranking system 108. Of course, it will be appreciated that user interface component 102 can request clarifying information in other ways as well. For instance, the user interface component 102 can generate a user interface display specifically asking the user to input additional information, instead of presenting potential factors 210 for selection by the user 106. The display of potential factors 210 for selection as shown FIG. 5 is provided by way of example only.

In the specific example shown in FIG. 5, the user 106 can interact with each of the factors 210 by selecting the “pin” or “remove” buttons 214 or 216, associated with each of the factors 210. Similarly, the user 106 can illustratively interact with the factors 210 in another way as well. For instance, by clicking directly on one of the factors 210, the user 106 can automatically replace the initially presented input query 104 with the selected factor 210. For example, by clicking on “battery is dead”, the “Why won't my car start?” text is replaced by “battery is dead” and the top factors 210 and solutions 212 corresponding to the new query “battery is dead” are displayed.

By clicking on the “pin” button 211 associated with a given factor 210, the user 106 indicates that this factor is relevant to the user's situation defined by the input query 104 input by the user 106. By “pinning” a factor that has a lower probability (such as by pinning the “key won't turn” factor) search and ranking system 108 can change the presented factors 210, the presented solutions 212, or both.

Similarly, by clicking the “remove” button 216 associated with the given factor 210, the user 106 is indicating that this factor is not relevant to the user's situation, as defined by the input query 104 input by the user 106. When a factor 210 is removed that has relatively high probability on the list of factors (such as when the “battery is dead” factor is removed) this may adjust the presented factors 210, the presented solutions 212, or both. Having system 100 present the opportunity for clarification to the user 106 is indicated by block 220 in FIG. 1, and receiving user inputs clarifying the information (such as pinning or removing factors) as indicated by block 222 in FIG. 4.

FIG. 6 illustrates an embodiment in which the user has removed the “battery is dead” factor. In response, search and ranking system 108 presents a new list of proposed solutions 212 and top factors 210, to the user. These correspond to proposed solutions 134 (in FIG. 1). It can be seen that search and ranking system 108 has replaced the initial top solutions 212 shown in FIG. 5 with two new solutions that account for the clarifying information provided by the user 106 in removing the “battery is dead” factor. That is, the old solutions 212 that were displayed for the user 106, and that focused on checking the battery, are replaced by new solutions 212 that are focused on other factors, such as being out of gas or relating to a situation where the key will not turn. Although, as shown in FIG. 6, the “battery is dead” factor is still visible, it is not considered in presenting the new list of solutions 212. Similarly, this allows the user 106 to undo the “remove” function, if desired. By way of specific example with respect to FIG. 6, the user 1.06 has indicated that the battery is not dead, which was the leading cause of why a car won't start. Therefore, the user's removal of that factor can adjust the top factors 210. For instance, the likelihood that the battery cables are loose is less when the user 106 removes this factor. Similarly, the top solutions 212 can be adjusted. For instance, those solutions that are focused on factors other than the top factor are re-prioritized.

Similarly, while the solutions 212 indicated in FIG. 6 are entirely new solutions, other options can be used as well. For instance, instead of providing all new solutions, different parts of the same documents can be presented to user 106 as a solution. That is, one part of a given document may be the most popular solution, but a less popular portion of the same document, that is nonetheless relevant to the one or more remaining factors, can be presented to this specific user 106 as a solution. Adjusting the presented solutions or presented factors, or both, is indicated by block 224 in FIG. 4.

FIGS. 5 and 6 also show that each of the proposed solutions 212 have a “pin” button 250 and a “remove” button 252. Therefore, when a user finds a solution 212 that addresses his or her problem, the user can actuate the “pin” button 250. Similarly, when the user reviews a solution 212 that does not address the problem, the user can actuate the “remove” button 252. This provides additional feedback to search and ranking system 108, so system 108 can adjust the factors 210, the solutions 212, or both. Similarly, when the user 106 selects the “pin” button 250, this indicates that the user 106 has approved, of a solution, because it has answered the problem posed by the input query 104. This provides additional feedback 136 to search and ranking system 108, and is indicated by block 226 in FIG. 4.

It should also be noted that search and ranking system 108 can request additional information from the user 106 as well. For instance, search and ranking system 108 may ask, through user interface component 102, for additional factors related to the input query 104, that will help the system 108 in providing search results for future queries. By way of example, and continuing with the scenario discussed with respect to FIGS. 5 and 6, the user 106 may be asked to provide the make and model of the car as a suggested factor. This can be stored by search and ranking system 108 in data store 110 as one of factors 118 associated with the “Why won't my car start?” query. It can also be associated with the solution selected by the user 106. The associations between the new factors and the queries and solutions can be generated using factor association component 120. Requesting additional factors based on an approved solution is indicated by block 228 in FIG. 4.

Based upon all the interactions with user 106, search and ranking system 108 and factor association component 120 illustratively recalculate probabilities and associations and add any new factors and associations learned from the interaction. This is indicated by block 230 in FIG. 4. For instance, machine learning component 124 may illustratively be a statistical machine learning component that receives the user's selection or removal of factors, and the user's approval of a solution as input. Component 124 then recalculates any associations among the factors 118, queries 116 and solutions 114 in data store 110, and also illustratively recalculates the strength of those associations, where a strength value is used. Similarly, search and ranking system 108 illustratively recalculates the probabilities associated with solutions 114 and factors 118, given the input query 104 input by the user 106.

Finally, once a user 106 has approved a solution, incentive generator 157 can access data store 110 to determine the author of the solution that has been approved. Incentive generator 157 then provides incentives 159, through community interface 150, to the member of community 152 that authored the solution. Of course, the incentives can take a wide variety of different forms. For instance, incentive generator 157 may simply accumulate point totals for various members of community 152 in certain subject matter areas based on how many of their solutions are selected. The point totals can be displayed to various users as recognition of “experts” in those subject matter areas, based on the point totals. Other incentives can be provided as well, such as further recognition in various forms, such as an award of products or services, or other items. Providing incentives is indicated by block 232 in FIG. 4.

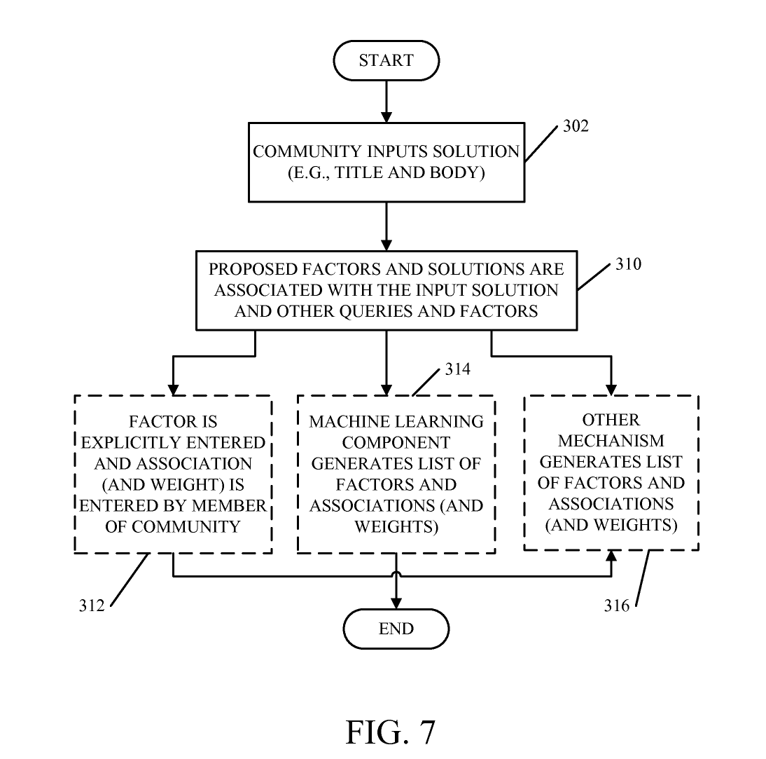

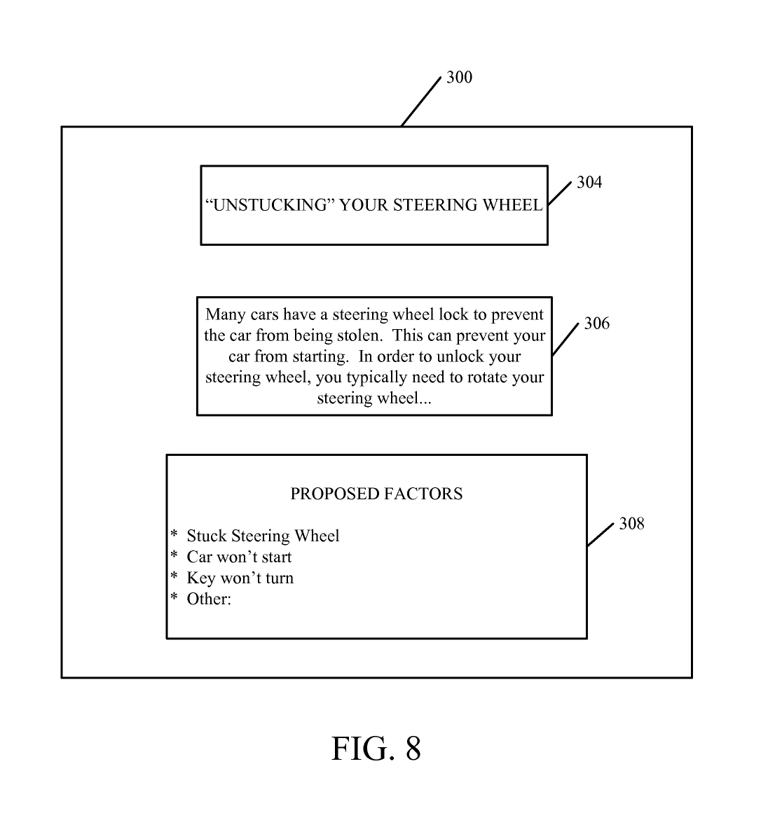

FIG. 7 is a flow diagram illustrating one embodiment of the operation of the system 100 (shown in FIG. 1) that includes community interface 150. FIG. 8 is one exemplary user interface 300. FIGS. 7 and 8 will now be described in conjunction with one another.

In order to generate data store 110, or to augment it, a member of community 152 can use community interface 150 to input new solutions 154, factors 156 and associations 158 among the solutions 154 and factors 156. FIG. 7 is a flow diagram illustrating one way to do this, and FIG. 8 is a user interface display 300 also indicating one way to do this. In the embodiment shown in FIGS. 7 and 8, a member of the community first inputs a solution 154 through community interface 150. This is indicated by block 302. In one embodiment, this can be done using the user interface display 300 in FIG. 8. A text box 304 can be provided to receive the solution title. Continuing with the example discussed above with respect to FIGS. 4-6, one solution input by the user can be “unstucking you steering wheel”.

The member of community 152 can then input a solution body which is a textual description that describes the solution title in box 304 in more detail. This can be done by inputting text into a solution body text box 306. The textual description in box 306 of FIG. 8 textually describes why a steering wheel might be locked and how to unlock it.

The member of community 152 can also input proposed factors 156 again through a text box 308 on interface 300. By inputting the factors in this way, factor association component 120 illustratively associates the factors in box 308 with the solution body in box 306 and the solution title in box 304. This can be done automatically using machine learning component 124 or manually, using administrator component 122. Weights can be assigned to the associations in these ways as well. Other mechanisms can generate these associations and weights as well. In addition, the proposed factors in block 308 can be associated with one another in any of these ways.

Similarly, factor association component 120 can also associate the proposed factors 308 with other solution titles or solution bodies. For instance, by comparing the text in the solution title and solution body with the text in other proposed solutions in data store 110, factor association component 120 can associate the factors in box 308, that have just been input by a member of the community 152, with other similar solutions already residing in data store 110. The solution title, solution body and proposed factors input by the member of community 152 can also automatically or manually be associated with other queries 116 that already reside in data store 110. Associating the newly input solution and proposed factors with one another and with other queries and factors is indicated by block 310 in FIG. 7, and some of the various ways that this can be done are indicated by blocks 312, 314 and 316 in FIG. 7.

Community interface 150 can regulate input by community 152 in different ways as well. For instance, changes input into database 110 can be undone by others. Similarly, if a member of community 152 has a reputation for putting in incorrect or improper information, that particular member of community 152 can be blocked from using interface 150.

In addition, the factors can be presented in different ways. For instance, the factors can be presented in a live, on-line way, such as through a chat room environment. In that embodiment, user 106 can be logged into a chat room where the proposed solutions and factors are provided in an interactive way. Similarly, an intelligent semantically driven component, or bot, can be used in user interface component 102 to present the various solutions and factors to user 106. The solutions and factors simply need not be provided in the lists that can be clicked on, although that is shown in the present Figures for the sake of example only.

Similarly, system 100 can be implemented in a public search environment. In one illustrative embodiment, system 100 can be implemented in a social network that has a public search system.

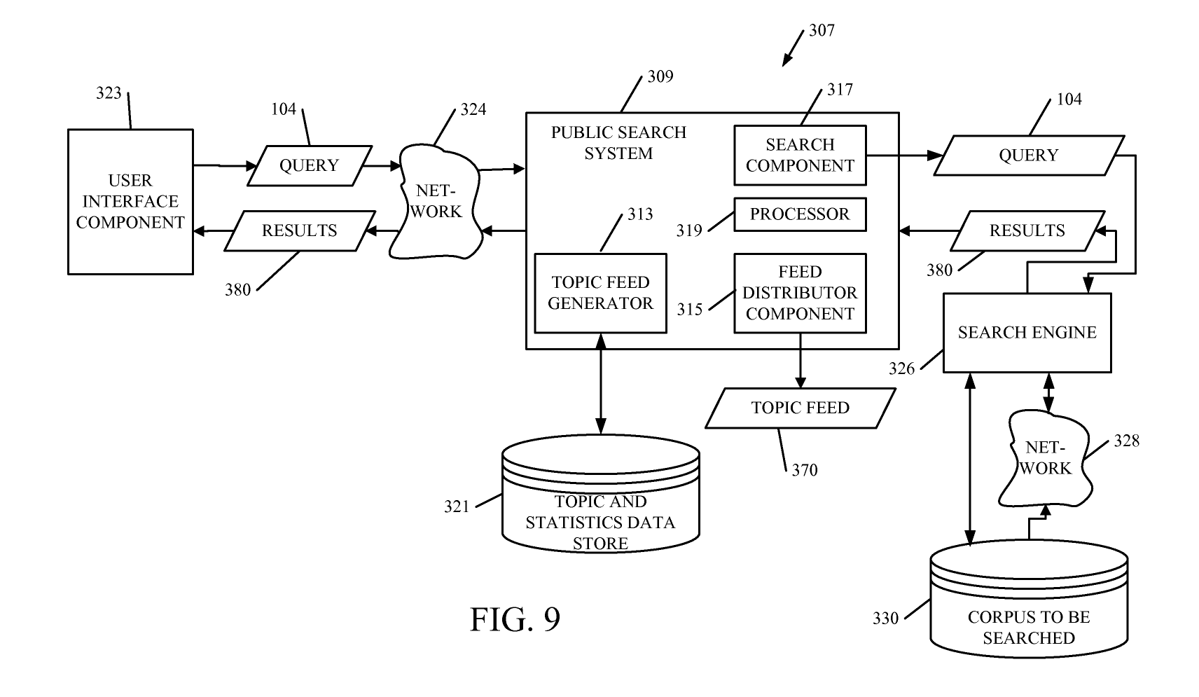

FIG. 9 is a simplified block diagram of one embodiment of a social network 307 that includes public search system 309. Public search system 309 illustratively includes topic feed generator 313, feed distributor component 315, search component 317 and processor 319. Search component 317 can correspond to search and ranking system 108 in FIGS. 1-8. Public search system 309 is also shown connected to a topic and statistics data store 321, in the embodiment shown in FIG. 9, public search system 309 is also illustratively connected to user interface component 323 which resides on a client device. The client device can be any suitable computing device, such as a laptop computer, a cellular telephone, any other type of personal digital assistant (PDA), other mobile device, or other computing device (such as a desktop computer). Data store 110 can be part of data store 321 or a separate data store. User interface component 102 can be part of user interface component 323 or the two can be different.

In the embodiment shown in FIG. 9, public search system 309 is shown connected to user interface component 323 through network 324. Network 324 can be a local area network, a wide-area network (such as the Internet) or any other desired network. Of course, user interface component 323 could also be directly connected to, or reside on, public search system 309. FIG. 9 also shows that public search system 309 is connected to search engine 326 which, itself, is connected either through a network 328, or directly, to a corpus 330 that is to be searched. Search engine 326 can be part of search and ranking system 108 and data store 110 can be part of corpus 330 as well.

It will be appreciated that the block diagram shown in FIG. 9 is exemplary only. The functions associated with the elements to be described can be combined into a single component, or further divided into more discrete components. Similarly, the connections shown in FIG. 9 can be through networks, or direct connections, and those shown are for exemplary purposes only.

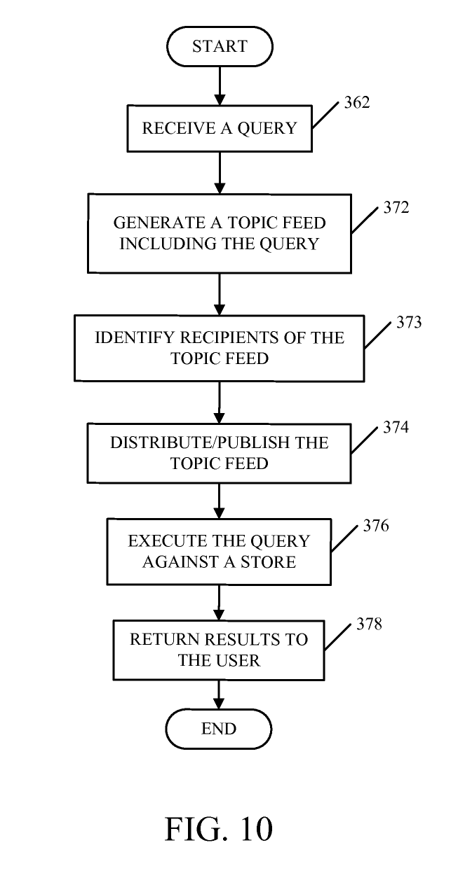

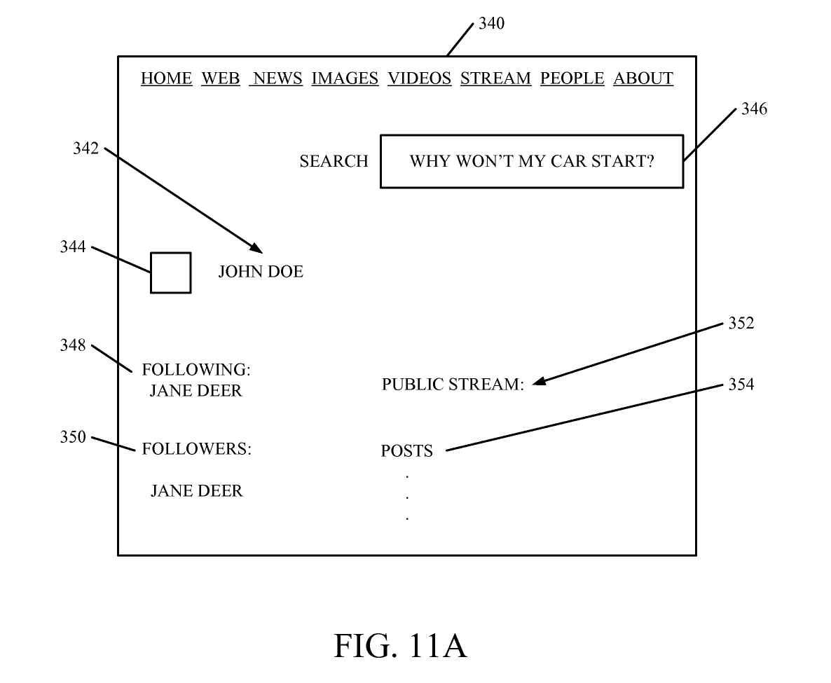

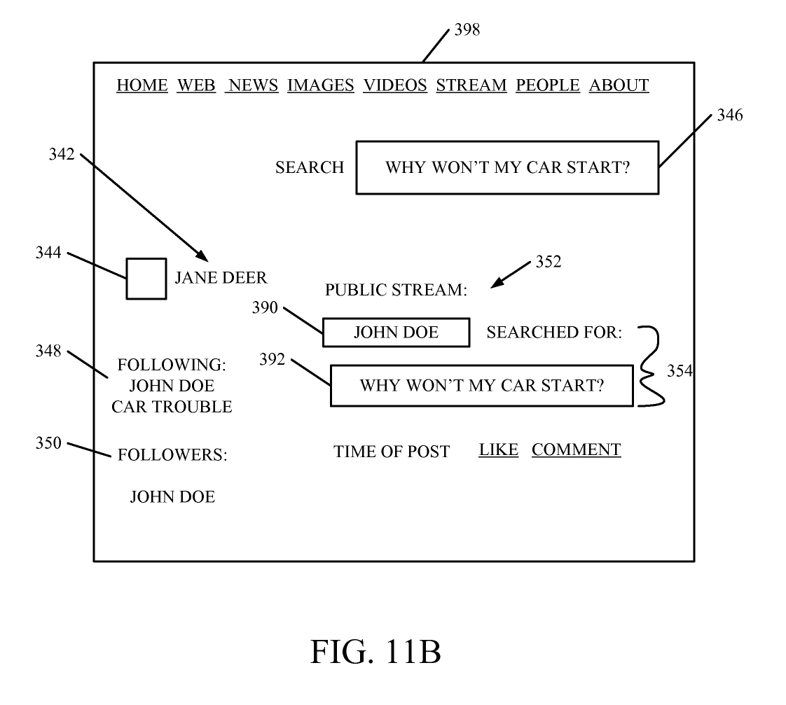

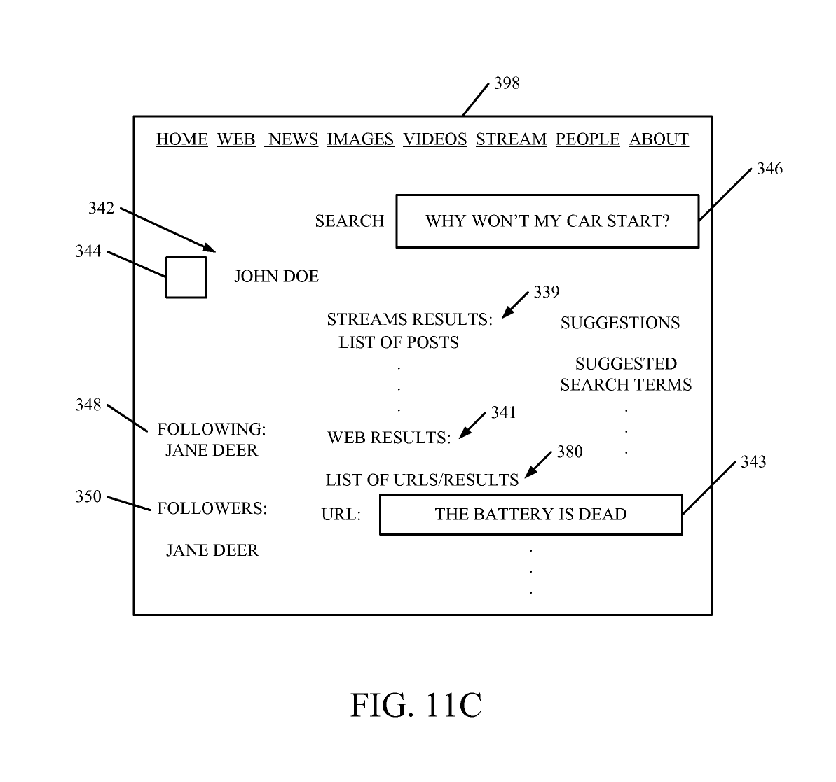

FIG. 10 is a simplified flow diagram illustrating one embodiment of the operation of social network 307 shown in FIG. 9. FIGS. 11A-11C show illustrative user interface displays corresponding to the operation of the system described with respect to FIG. 10. FIGS. 9-11C will be described in conjunction with one another.

User interface component 323 illustratively resides on a user's system, which may be a client device. In one embodiment, in order to use network 307, a user first engages user interface component 323 to set up an account which includes, for example, a user name and password. The user inputs these items through interface component 323, and they are stored in topic and statistics data store 321. The user is illustratively able to identify topics of interest which the user wishes to follow, or individual users or groups of users that the user wishes to follow as well. This information is also stored in data store 321. This can all be done through user interface displays generated by component 323.

Once this is done, and the user wishes to use network 307, the user illustratively logs on to system 309, through an authentication component and user interface component 323 generates a user interface display 340 such as that shown in FIG. 11A. In the illustrative user interface display 340, the user's user name is John Doe and that is displayed generally at 342, along with an image 344 which can be selected by John Doe to represent his user name. The display also presents a search box 346, which is a text box that allows the user 106 to enter text (such as by using a keyboard) that represents an input query 104 that the user 106 wishes to have executed. Interface display 340 also illustratively displays the user names or topics that user 342 is following. This is generally indicated at 348. User interface display 340 may also illustratively list other users that are following user 342. This is generally indicated at 350. In addition, user interface display 340 displays a public stream of information 352, which has already been generated. The public stream 352 illustratively includes a plurality of posts 354, corresponding to received topic feeds 370 which will be described in greater detail below. Further, user interface display 340 illustratively includes a set of actuable elements generally shown at 301. By actuable (or actuatable) elements, it is meant that the elements can be actuated through a suitable user interface operation, such as by clicking on an element using a pointing device (like a mouse or double-clicking, or otherwise. These are described in greater detail below as well.

When the interface display 340 is displayed by user interface component 323, the user can enter a desired query 104 into textbox 346. In the example shown in FIG. 11A, the user has typed in “why won't my car start?”. This corresponds to input query 104 shown in FIG. 9. The query is sent from user interface component 323 to public search component 309, and specifically to topic feed generator 313. Receipt of input query 104 by public search system 309 is illustrated by block 362 in FIG. 10.

Topic feed generator 313, in response to receiving input query 104, generates a topic feed that includes query 104 and that is to be output in the public stream 352 as a topic feed 370. Generating the topic feed 370, including the query 104, is indicated by block 372 in FIG. 10.

Feed distributor component 315 then accesses data store 321 to identify the followers of both John Doe (the user that submitted input query 104) and the followers of the subject matter content of the input query 104, itself. For instance, the subject matter content of query 104 is illustratively “car trouble”. Therefore, if any users have indicated that they wish to follow the topic category (or subject matter category) “car trouble”, then they would be identified by feed distributor component 315 as a recipient of topic feed 370 as well. Feed distributor component 315 then distributes or publishes the topic feed 370 to those recipients that were identified. Identifying recipients is indicated by block 373 in FIG. 10, and distributing the topic feed 370 to the recipients is indicated by block 374 in FIG. 10. It can thus be seen that upon submission of input query 104, system 309 automatically publishes that query 104 in a topic feed to all relevant recipients, without any further input from the user 106.

The distribution or publication can be done in other was as well. For instance, feed distribution component 315 can wait to update the system of a recipient until the recipient logs on to the system or otherwise engages the system. Similarly, the feed distribution component 315 can wait to distribute topic feed 370 to recipients until after the user 106 has interacted with the results from the query 104 (as described below).

It should be noted that, in FIG. 11A, a wide variety of other embodiments can be used. For instance, public stream 352 may be divided into two streams, one which reflects posts from people that the user is following and the other that reflects posts from topic areas that the user is following. Of course, a wide variety of other changes can be made to the display shown in FIG. 11A, as well.

Once the topic feed 370 has been distributed and published to the identified recipients, a user interface component 323 (corresponding to the recipients) illustratively generates a display for those recipients, such as shown in FIG. 11B. FIG. 11B is similar to that shown in FIG. 1 IA, except that the user 342 is indicated as Jane Deer. It can be seen from FIG. 11A that Jane Deer is one of the followers of John Doe. Therefore, the topic feed 370 generated from any activity of John Doe will be distributed, to, and published at, a user interface component 323 residing at Jane Deer's device.

The topic feed 370 is posted as a post 354 on the public stream 352 of the user interface display shown in FIG. 11B. It can be seen in FIG. 11B that the public stream 352 includes the post “John Doe searched for why won't my car start?”. FIG. 11B shows that both the source of the post and the search which is the subject matter of the post are actuable links, and this is indicated by boxes 390 and 392 in FIG. 11B. Therefore, the term “John Doe” is included in box 390 and the query “why won't my car start?” is included in box 392. If the user of the system that generated the display in FIG. 11B (that is, Jane Deer) clicks on the text in either box 390 or 392, then the user's system takes action. If the user clicks on box 390, which contains the source of the post, then the user's system links the user to the home page of the person identified in box 390 (John Doe). Therefore, if Jane Deer clicks on box 390 that includes “John Doe”, then Jane Deer's system navigates to the home page for John Doe, and presents Jane Deer with a user interface display such as that shown in FIG. 11A. If Jane Deer clicks on box 392, the results for that query will be returned to Jane Deer. This will be described in more detail below.

At the same time that feed distributor component 315 is distributing the topic feed generated by generator 313, search component 317 is also providing input query 104 to search engine 326 (which can include system 108) for execution against corpus 330. Search engine 326 may illustratively be search and ranking system 108 that searches for matching queries 116, solutions 114 and factors 118 as described above with respect to FIGS. 1-8. This information can be part of the topic feed 370 and public stream 352. Search engine 326 can alternatively be implemented in search component 317. Search engine 326 executes the search against corpus 330 and returns search results 380 to search component 317 in public search system 309. Search component 317 then returns results 380 to user interface component 323 corresponding to the author of the input query 104 (that is, corresponding to John Doe).

Not only does search component 317 pass query 360 on to search engine 326 for execution against corpus 330, but search component 317 also searches the records stored in data store 321 for any other posts that are relevant to the subject matter of query 104. It may be that John Doe or other users of public search system 309 have submitted similar queries, and therefore topic feeds 370 may have already been generated for those similar queries. Thus, search component 317 searches data store 321 for posts from previously generated topic feeds 370 that are relevant to input query 104. These are returned to the user through user interface component 323 as stream results 381. In other embodiments, the records returned, from searching data store 321 can be used to re-order search results 380 returned from search engine 326 or a search engine other than search engine 326.

User interface component 323 then generates a display 398 for the user (who submitted, the query) such as that shown in FIG. 11C. The display shown in FIG. 1 IC is similar to that shown in FIG. 11A, and similar items are similarly numbered. However, there are a number of differences. It can be seen that FIG. 1 IC shows that the search results are presented in two separate categories. The first is stream results section 339 and the second is web results section 341. Under web results section 341, the search results 380 generated by search engine 326 are presented to the user as user actuable links. By way of example, one of results 380 is a URL entitled “battery is dead”, it is shown in a box 343 to indicate that it is actuable on display 398. That is, if the user clicks on one of the results 380, the user will be taken to the web page, or other corpus entry, that spawned that search result.

Under stream results section 339, user interface display 398 lists all posts which contain search results 381 relevant to input query 104. That is, if data store 321 included posts that were relevant to the query 104, those posts are also displayed in the stream results 381, along with the web results 380. Again, to the extent that there are any actuable links in stream results 381, posted in stream results section 339, the user can simply click on those actuable links and be taken to the underlying source that spawned the link.

FIG. 11C also shows that system 309 can suggest additional search strategies. This is shown generally at 345.

It should also be noted that, in one embodiment, not only is the public stream 352 filled with topic feeds 370 that contain queries, but it also contains other search activities by users, such as whether the user interacted with (clicked on, liked, unliked, etc.) one of the results 380 or 381 returned in response to a query 104, or whether the user actuated any of the links in the public stream 352.

FIG. 12 is one embodiment of a computing environment which the invention can be used. With reference to FIG. 12, an exemplary system for implementing some embodiments includes a general-purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 9 illustrates operating system 434, application programs 435, other program modules 436, and program data 437. The systems discussed above in FIGS. 1-11C can be stored in other program modules 436 or elsewhere, including being stored remotely. The components can be implemented in the computing environment and activated by processing unit 420 to facilitate the functions and characteristics described above.

The computer 410 may also include other removable/non-removable volatile/nonvolatile computer storage media. By way of example only, FIG. 12 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 12, provide storage of computer readable instructions, data structures, program modules and other data for the computer 410. In FIG. 12, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. They can also include search components 402 and 404.

FIG. 12 shows the clustering system in other program modules 446. It should be noted, however, that it can reside elsewhere, including on a remote computer, or at other places.

A user may enter commands and information into the computer 410 through input devices such as a keyboard 462, a microphone 463, and a pointing device 461, such as a mouse, trackball or touch pad. Other input devices (not shown) may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB), A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 is operated in a networked environment using logical connections to one or more remote computers, such as a remote computer 480. The remote computer 480 may be a personal computer, a hand-held device, a server, a router, a network PC, a peer device or other common network node, and typically includes many or all of the elements described above relative to the computer 410. The logical connections depicted in FIG. 12 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 12 illustrates remote application programs 485 as residing on remote computer 480. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of retrieving information in response to an input query, performed by a computer with a processor, the method comprising:
receiving the input query;
searching a data store, with the processor, based on the input query, and identifying factors that augment information in the input query to further define a problem defined in the input query and that are associated with the input query;
searching the data store, with the processor, to identify a first set of proposed solutions to the problem defined by the input query;
identifying, with the processor, the first set of proposed solutions as solutions that are relevant to the input query and that are associated with at least some of the factors that are associated with the input query;
displaying, with a user interface component, the first set of proposed solutions along with the factors associated with the first set of proposed solutions, and a user interface element that receives clarifying information that clarifies the problem defined by the input query; and
displaying a second set of proposed solutions, along with factors associated with the second set of proposed solutions, based on the input query and the clarifying information.

2. The computer-implemented method of claim 1 wherein identifying the first set of proposed solutions comprises:
identifying the most likely set of proposed solutions given the input query and the factors associated with the input query.

3. The computer-implemented method of claim 2 wherein displaying the second set of proposed solutions comprises:
identifying the second set of proposed solutions as proposed solutions that are less likely that the first set of proposed solutions given the input query and the factors associated with the input query but that are more likely than the first set of proposed solutions given the input query, the factors associated with the input query and the clarifying information.

4. The computer-implemented method of claim 3 wherein displaying a user interface element that receives clarifying information comprises:
displaying the factors associated with the first set of proposed solutions as selectable items that can be selected or removed from consideration by the processor in identifying proposed solutions.

5. The computer-implemented method of claim 4 wherein displaying the factors as selectable items comprises:
displaying buttons along with each factor that, when actuated, indicate that the factor is either selected or removed.

6. The computer-implemented method of claim 4 wherein displaying the factors as selectable items comprises:
displaying the factors as directly selectable, and, when a factor is selected, automatically replacing the input query with the selected factor and repeating the steps of searching the data store to identify the first set of proposed solutions, identifying the first set of proposed solutions, and displaying the first set of proposed solutions using the selected factor instead of the input query.

7. The computer-implemented method of claim 1 wherein identifying factors that augment information in the input query comprises identifying a matching query, stored in the data store, that matches the input query, along with factors associated in the data store with the matching query.

8. The computer-implemented method of claim 1 wherein displaying a proposed solution comprises:
displaying a selectable approval input corresponding to each displayed proposed solution, the approval input being selectable to indicate user approval of the corresponding proposed solution.

9. The computer-implemented method of claim 8 and further comprising:
receiving user selection of an approval input indicating approval of the corresponding proposed solution; and
revising scores associated with the proposed solution corresponding to the selected approval input to reflect the user approval of the proposed solution.

10. The computer-implemented method of claim 1 and further comprising:
automatically generating associations between factors and proposed solutions based on the clarifying information.

11. The computer-implemented method of claim 1 and further comprising:
automatically generating associations between factors and stored queries based on the clarifying information.

12. The computer-implemented method of claim 1 and further comprising:
automatically generating associations among factors based on the clarifying information.

13. The computer-implemented method of claim 1 wherein each association has a corresponding weight that indicates a strength of the association, and further comprising:
adjusting the weights corresponding to the associations based on the clarifying information.

14. The method of claim 9 and further comprising:
issuing an incentive to an author of the proposed solution corresponding to the selected approval input.

15. A question response system, comprising:
a user interface component that receives an input query that defines a problem;
a data store that stores community-authored queries, solutions and factors, the factors providing additional information related to the queries and solutions;
a factor association component generating associations between the factors and both the queries and the solutions, and among the factors;
a community interface component receiving, and storing in the data store, the community authored queries, solutions and factors;
a search and ranking component that identifies a stored similar query as being similar to the input query, that identifies factors associated with the stored, similar query and that uses the stored, similar query and its associated factors to identify a first set of proposed solutions to the problem defined by the input query, the user interface component displaying the first set of proposed solutions and the associated factors and displaying a selectable element that receives a user input changing the factors to be used by the search and ranking component, the search and ranking component identifying a second set of proposed solutions based on the changed factors; and
a computer processor that is a functional component of the system and that is activated by the user interface component, the factor association component, the community interface component, and the search and ranking component to facilitate generating associations, receiving community authored solutions and factors, and identifying similar queries and factors and proposed solutions.

16. The system of claim 15 wherein the factor association component generates additional associations based on the user input changing the factors.

17. The system of claim 16 wherein the factor association component comprises:
an administrator component that receives manual input of associations; and
a machine learning component that automatically generates associations based on a plurality of different user inputs.

18. The system of claim 15 wherein the user interface component displays a solution selection input that receives a user selection of a proposed solution, and further comprising:
an incentives generator that generates incentives for community members that author proposed solutions that are selected.

19. A computer implemented method, comprising:
receiving an input query;
identifying a first set of proposed solutions, authored by a community of users, that are most likely to address the input query, based on the input query and a set of factors associated with the input query;
displaying the first set of proposed solutions and an indication of the set of factors that were considered in identifying the first set of proposed solutions;
displaying a user interface element that receives a user input changing the set of factors;
identifying a second set of proposed solutions based on the input query and a changed set of factors obtained based on the user input;
displaying the second set of proposed solutions and the changed set of factors considered in identifying the second set of proposed solutions;
receiving user approval of one of the second set of proposed solutions;
modifying associations among proposed solutions and factors based on the user approval; and
generating an incentive for a community member that authored the one proposed solution approved by the user.

20. The method of claim 19 wherein the factors are associated with the proposed solutions by weighted associations, and further comprising:
revising the weighted associations based on inputs from users and from the community.
